(19) United States
(12) Patent Application Publication
(10) Pub. No.: US 2008/0277214 A1
(43) Pub. Date: Nov. 13, 2008

(54) Electromagnetic brake device

(76) Inventor: Feng-Chu Chang, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/801,361

(22) Filed: May 10, 2007

(51) Int. Cl. B60L 7/00

(52) U.S. Cl. 188/161

(57) ABSTRACT

An electromagnetic brake device includes a motor, a control mechanism and an operation unit. The control mechanism includes a fixed seat, an electromagnetic valve, a press button and a rotation plate. The operation unit includes a mounting tube, a locking bar, a push button, and an elastic member. Thus, a user only needs to press the push button to lock or unlock the operation unit and the control mechanism to control operation of the electromagnetic valve so as to control the braking operation of the brake disc, so that the electromagnetic brake device is operated easily and quickly, thereby facilitating the user operating the electromagnetic brake device.

### BACKGROUND OF THE INVENTION

1. Field of the Invention

The present invention relates to a brake device and, more particularly, to an electromagnetic brake device.

2. Description of the Related Art

A conventional electromagnetic brake device comprises a brake disc movably mounted on a propeller shaft to provide a braking effect to a wheel mounted on the propeller shaft, an electromagnetic valve connected to the brake disc, and a control circuit connected to the electromagnetic valve to control operation of the electromagnetic valve. The brake disc has a magnetically attractive face and a friction face. In operation, when the electromagnetic valve is energized by the control circuit, the electromagnetic valve produces a magnetic force to attract the magnetically attractive face of the brake disc to drive the friction face of the brake disc to press a wheel rim of the wheel to provide a braking effect to the wheel.

### BRIEF SUMMARY OF THE INVENTION

In accordance with the present invention, there is provided an electromagnetic brake device, comprising a motor, a control mechanism and an operation unit. The motor is provided with a recessed stop portion. The control mechanism includes a fixed seat mounted on the motor, an electromagnetic valve mounted on the fixed seat, a press button retractably mounted on the electromagnetic valve to control operation of the electromagnetic valve, and a rotation plate rotatably mounted on the fixed seat and rotatable relative to the fixed seat between a first position where a peripheral wall of the rotation plate presses the press button toward the electromagnetic valve to drive the electromagnetic valve to control the brake disc and a second position where a receiving opening of the peripheral wall of the rotation plate receives the press button so that the press button protrudes outwardly from the electromagnetic valve to stop operation of the electromagnetic valve. The operation unit is mounted between the motor and the control mechanism and movable between a first position where the operation unit is movable freely to rotate the rotation plate of the control mechanism relative to the fixed seat of the control mechanism so that the peripheral wall of the rotation plate presses the press button of the control mechanism, and a second position where the operation unit is stopped by the stop portion of the motor and the receiving opening of the rotation plate receives the press button so that the press button protrudes outwardly from the electromagnetic valve of the control mechanism.

The primary objective of the present invention is to provide an electromagnetic brake device that is operated by pressing a push button.

Another objective of the present invention is to provide an electromagnetic brake device, wherein a user only needs to press the push button to lock or unlock the operation unit and the control mechanism to control operation of the electromagnetic valve so as to control the braking operation of the brake disc, so that the electromagnetic brake device is operated easily and quickly, thereby facilitating the user operating the electromagnetic brake device.

A further objective of the present invention is to provide an electromagnetic brake device, wherein the electromagnetic brake device is assembled easily and quickly, thereby facilitating the user mounting the electromagnetic brake device.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of an electromagnetic brake device in accordance with the preferred embodiment of the present invention.

FIG. 2 is a partially exploded perspective view of the electromagnetic brake device as shown in FIG. 1.

FIG. 3 is a partially side cross-sectional view of the electromagnetic brake device as shown in FIG. 1.

FIG. 4 is another perspective view of the electromagnetic brake device as shown in FIG. 1.

FIG. 5 is a partially exploded perspective view of the electromagnetic brake device as shown in FIG. 4.

FIG. 6 is a schematic operational view of the electromagnetic brake device as shown in FIG. 1.

FIG. 7 is a schematic operational view of the electromagnetic brake device as shown in FIG. 6.

### DETAILED DESCRIPTION OF THE INVENTION

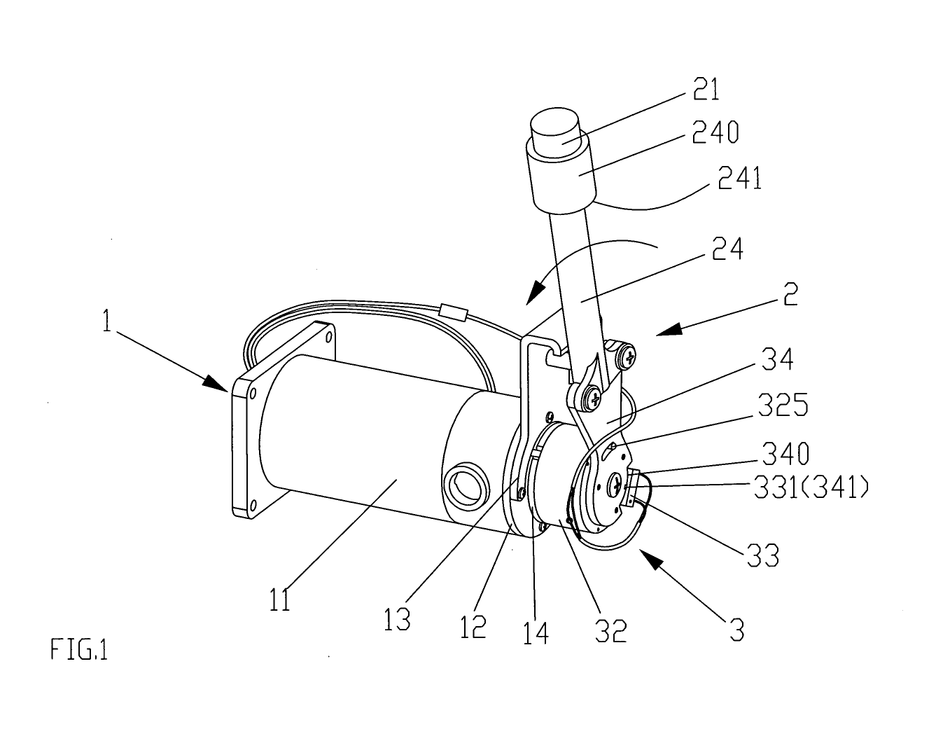

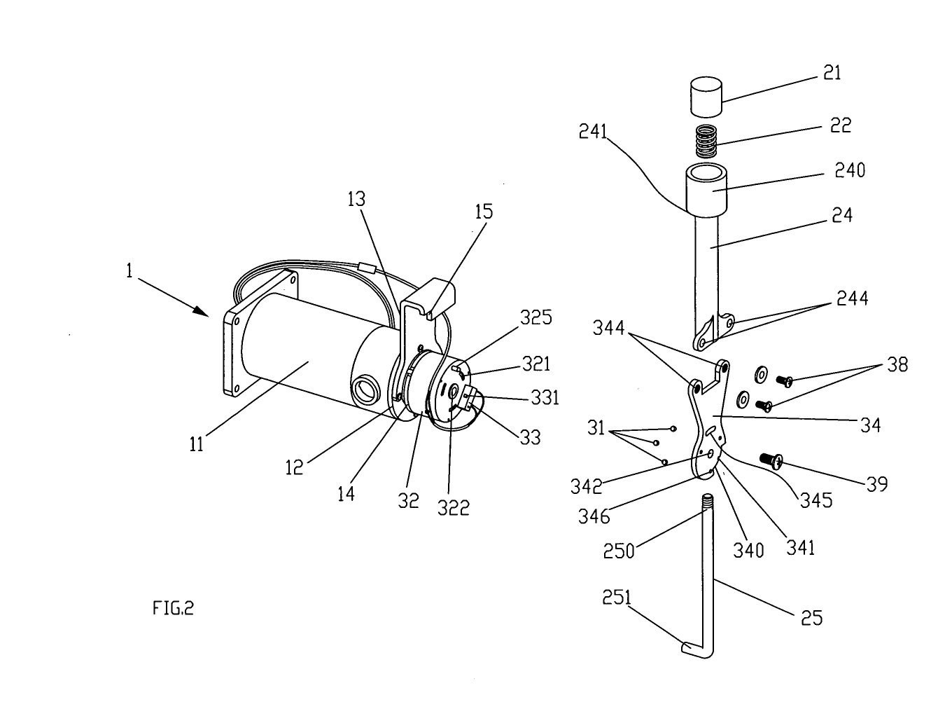

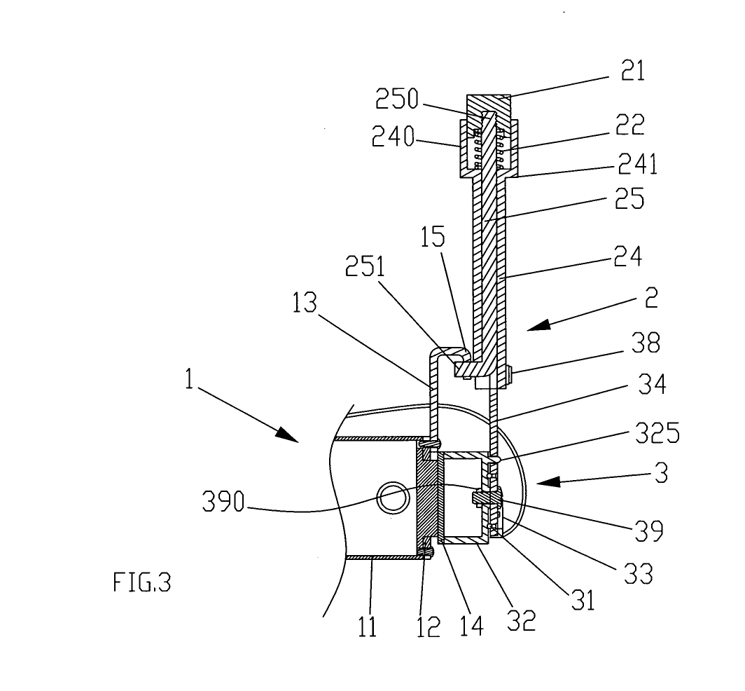

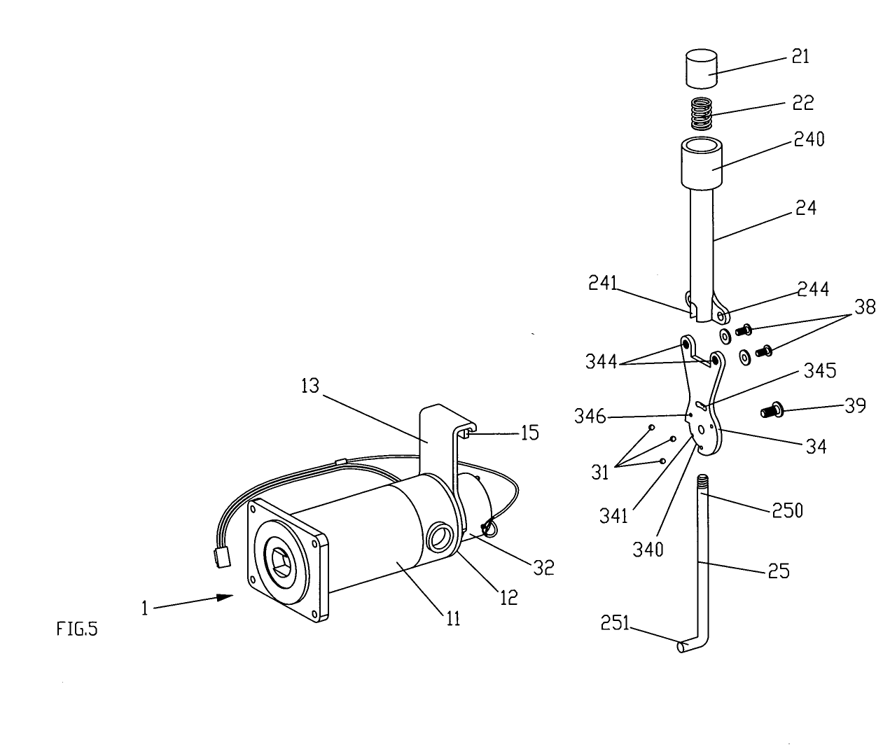

Referring to the drawings and initially to FIGS. 1-5, an electromagnetic brake device in accordance with the preferred embodiment of the present invention comprises a motor 1, a control mechanism 3 and an operation unit 2.

The motor 1 is provided with a recessed stop portion 15.

The control mechanism 3 includes a fixed seat 32 mounted on the motor 1, an electromagnetic valve 33 mounted on the fixed seat 32 and connected to a brake disc (not shown), a press button 331 retractably mounted on the electromagnetic valve 33 to control operation of the electromagnetic valve 33, and a rotation plate 34 rotatably mounted on the fixed seat 32 and rotatable relative to the fixed seat 32 between a first position where a peripheral wall 340 of the rotation plate 34 presses the press button 331 toward the electromagnetic valve 33 to drive the electromagnetic valve 33 to control the brake disc and a second position where a receiving opening 341 of the peripheral wall 340 of the rotation plate 34 receives the press button 331 so that the press button 331 protrudes outwardly from the electromagnetic valve 33 to stop operation of the electromagnetic valve 33.

The operation unit 2 is mounted between the motor 1 and the control mechanism 3 and movable between a first position where the operation unit 2 is movable freely to rotate the rotation plate 34 of the control mechanism 3 relative to the fixed seat 32 of the control mechanism 3 so that the peripheral wall 340 of the rotation plate 34 presses the press button 331 of the control mechanism 3, and a second position where the operation unit 2 is stopped by the stop portion 15 of the motor 1 and the receiving opening 341 of the rotation plate 34 receives the press button 331 so that the press button 331 protrudes outwardly from the electromagnetic valve 33 of the control mechanism 3.

In the preferred embodiment of the present invention, the motor 1 includes a cylindrical housing 11, a washer 12 mounted on a side of the housing 11, an upright limit plate 13 having a lower end mounted on the washer 12 and an upper end provided with the stop portion 15, and a pad 14 mounted between the limit plate 13 and the fixed seat 32 of the control mechanism 3. The limit plate 13 of the motor 1 has a substantially 7-shaped cross-sectional profile.

The control mechanism 3 is mounted between the motor 1 and the operation unit 2. The fixed seat 32 of the control mechanism 3 has a substantially cylindrical shape and has a surface formed with a protruding limit post 325 and a plurality of substantially arc-shaped guide slots 321. The rotation plate 34 of the control mechanism 3 has a lower portion rotatably mounted on the fixed seat 32 by a pivot screw 39 which is extended through a through hole 342 of the rotation plate 34 and a through bore 322 of the fixed seat 32 and screwed into a nut 390. The lower portion of the rotation plate 34 of the control mechanism 3 has a surface formed with a substantially arc-shaped limit slot 345 slidable on the limit post 325 of the fixed seat 32 to limit rotation of the rotation plate 34 relative to the fixed seat 32 and a plurality of ball holes 346 to receive a plurality of balls 31 which are slidable in the guide slots 321 of the fixed seat 32 respectively to guide rotation of the rotation plate 34 relative to the fixed seat 32.

The operation unit 2 includes a mounting tube 24 having a lower portion secured on an upper portion of the rotation plate 34 of the control mechanism 3 to rotate the rotation plate 34 of the control mechanism 3, a locking bar 25 movably mounted in the mounting tube 24 and having a lower portion formed with a protruding locking portion 251 protruded outwardly from the lower portion of the mounting tube 24 and detachably locked in the stop portion 15 of the motor 1 to detachably lock the mounting tube 24 onto the stop portion 15 of the motor 1, a push button 21 movably mounted on an upper portion 240 of the mounting tube 24 and secured to an upper portion 250 of the locking bar 25 to move the locking bar 25 to detach the locking portion 251 of the locking bar 25 from the stop portion 15 of the motor 1, and an elastic member 22 mounted on the locking bar 25 and biased between the upper portion 240 of the mounting tube 24 and the push button 21 to push the push button 21 outwardly from the upper portion 240 of the mounting tube 24 and to push the locking portion 251 of the locking bar 25 into the stop portion 15 of the motor 1.

The elastic member 22 of the operation unit 2 is received in the upper portion 240 of the mounting tube 24, and the upper portion 240 of the mounting tube 24 has a stepped shoulder 241 to stop the elastic member 22. The lower portion of the mounting tube 24 of the operation unit 2 is secured on the upper portion of the rotation plate 34 of the control mechanism 3 by two locking screws 38 which are extended through two fixing holes 244 of the lower portion of the mounting tube 24 of the operation unit 2 and screwed into two screw bores 344 of the upper portion of the rotation plate 34 of the control mechanism 3. The locking bar 25 of the operation unit 2 has a substantially inverted L-shaped profile. The lower portion of the mounting tube 24 has a side formed with an elongated slideway 241 in which the locking portion 251 of the locking bar 25 is movable.

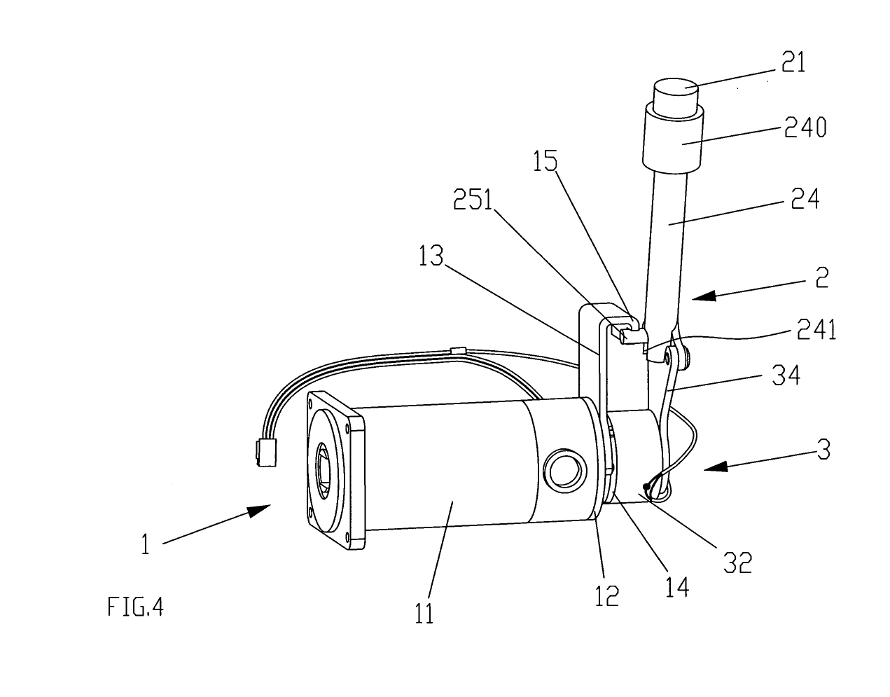

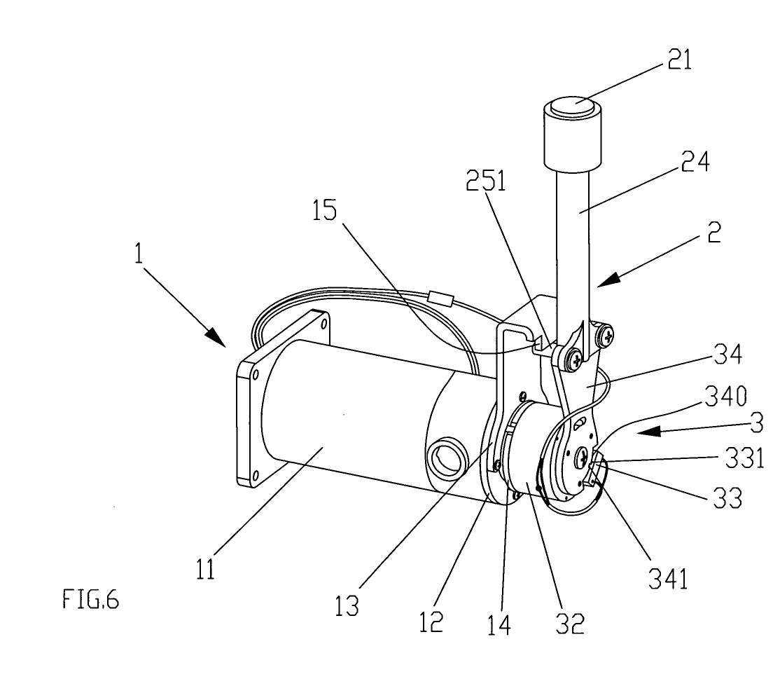

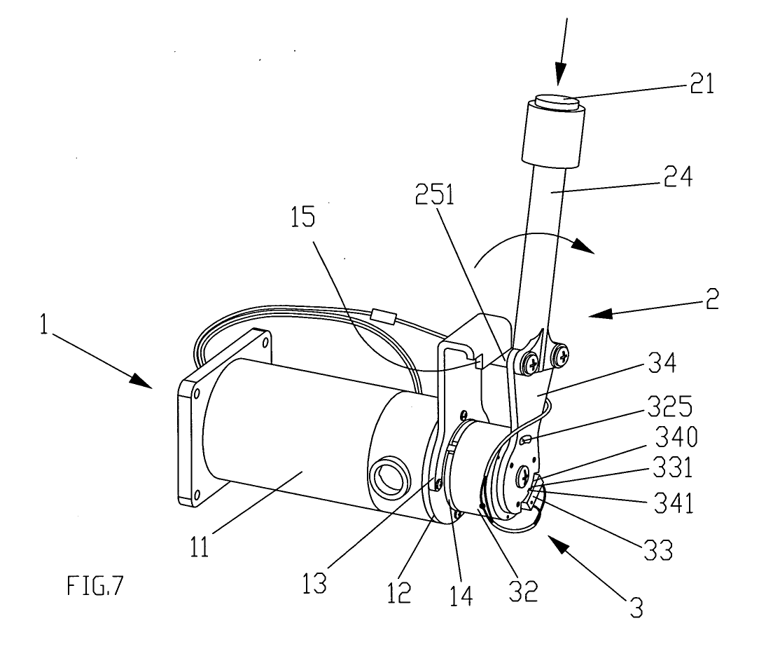

In operation, referring to FIGS. 6 and 7 with reference to FIGS. 1-5, the elastic member 22 pushes the push button 21 outwardly from the upper portion 240 of the mounting tube 24 and pushes the locking portion 251 of the locking bar 25 into the stop portion 15 of the motor 1 as shown in FIGS. 1 and 4 so that the mounting tube 24 of the operation unit 2 is locked onto the stop portion 15 of the motor 1 to lock the rotation plate 34 to prevent the rotation plate 34 from being rotatable relative to the fixed seat 32. Thus, when the locking portion 251 of the locking bar 25 of the operation unit 2 is locked in the stop portion 15 of the motor 1, the receiving opening 341 of the rotation plate 34 receives the press button 331 as shown in FIG. 1 so that the press button 331 protrudes outwardly from the electromagnetic valve 33 of the control mechanism 3 to stop operation of the electromagnetic valve 33.

On the contrary, when the push button 21 is pushed toward the locking bar 25, the locking bar 25 is movable downward in the mounting tube 24 to detach the locking portion 251 of the locking bar 25 from the stop portion 15 of the motor 1 to unlock the mounting tube 24 of the operation unit 2 from the stop portion 15 of the motor 1 and to unlock the rotation plate 34 so that the rotation plate 34 is rotatable freely relative to the fixed seat 32 as shown in FIGS. 6 and 7. Thus, when the rotation plate 34 of the control mechanism 3 is rotatable freely relative to the fixed seat 32, the peripheral wall 340 of the rotation plate 34 presses the press button 331 of the control mechanism 3 toward the electromagnetic valve 33 successively to drive the electromagnetic valve 33 to control the brake disc to provide a braking effect.

Accordingly, a user only needs to press the push button 21 to lock or unlock the operation unit 2 and the control mechanism 3 to control operation of the electromagnetic valve 33 so as to control the braking operation of the brake disc, so that the electromagnetic brake device is operated easily and quickly, thereby facilitating the user operating the electromagnetic brake device. In addition, the electromagnetic brake device is assembled easily and quickly, thereby facilitating the user mounting the electromagnetic brake device.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. An electromagnetic brake device, comprising:
a motor provided with a recessed stop portion;
a control mechanism including a fixed seat mounted on the motor, an electromagnetic valve mounted on the fixed seat, a press button retractably mounted on the electromagnetic valve to control operation of the electromagnetic valve, and a rotation plate rotatably mounted on the fixed seat and rotatable relative to the fixed seat between a first position where a peripheral wall of the rotation plate presses the press button toward the electromagnetic valve to drive the electromagnetic valve to control the brake disc and a second position where a receiving opening of the peripheral wall of the rotation plate receives the press button so that the press button protrudes outwardly from the electromagnetic valve to stop operation of the electromagnetic valve;
an operation unit mounted between the motor and the control mechanism and movable between a first position where the operation unit is movable freely to rotate the rotation plate of the control mechanism relative to the fixed seat of the control mechanism so that the peripheral wall of the rotation plate presses the press button of the control mechanism, and a second position where the operation unit is stopped by the stop portion of the motor and the receiving opening of the rotation plate receives the press button so that the press button protrudes outwardly from the electromagnetic valve of the control mechanism.

2. The electromagnetic brake device in accordance with claim 1, wherein the rotation plate of the control mechanism has a lower portion rotatably mounted on the fixed seat.

3. The electromagnetic brake device in accordance with claim 2, wherein:
the fixed seat of the control mechanism has a surface formed with a protruding limit post;
the lower portion of the rotation plate of the control mechanism has a surface formed with a substantially arc-shaped limit slot slidable on the limit post of the fixed seat to limit rotation of the rotation plate relative to the fixed seat.

4. The electromagnetic brake device in accordance with claim 2, wherein:
the fixed seat of the control mechanism has a surface formed with a plurality of substantially arc-shaped guide slots;
the lower portion of the rotation plate of the control mechanism has a surface formed with a plurality of ball holes to receive a plurality of balls which are slidable in the guide slots of the fixed seat respectively to guide rotation of the rotation plate relative to the fixed seat.

5. The electromagnetic brake device in accordance with claim 1, wherein the operation unit includes:
a mounting tube having a lower portion secured on an upper portion of the rotation plate of the control mechanism to rotate the rotation plate of the control mechanism;
a locking bar movably mounted in the mounting tube and having a lower portion formed with a protruding locking portion protruded outwardly from the lower portion of the mounting tube and detachably locked in the stop portion of the motor to detachably lock the mounting tube onto the stop portion of the motor;
a push button movably mounted on an upper portion of the mounting tube and secured to an upper portion of the locking bar to move the locking bar to detach the locking portion of the locking bar from the stop portion of the motor;
an elastic member mounted on the locking bar and biased between the upper portion of the mounting tube and the push button to push the push button outwardly from the upper portion of the mounting tube and to push the locking portion of the locking bar into the stop portion of the motor.

6. The electromagnetic brake device in accordance with claim 5, wherein the lower portion of the mounting tube has a side formed with an elongated slideway in which the locking portion of the locking bar is movable.

7. The electromagnetic brake device in accordance with claim 1, wherein the motor includes:
a cylindrical housing;
a washer mounted on a side of the housing;
an upright limit plate having a lower end mounted on the washer and an upper end provided with the stop portion;
a pad mounted between the limit plate and the fixed seat of the control mechanism.

8. The electromagnetic brake device in accordance with claim 5, wherein when the locking portion of the locking bar of the operation unit is locked in the stop portion of the motor, the receiving opening of the rotation plate receives the press button so that the press button protrudes outwardly from the electromagnetic valve of the control mechanism to stop operation of the electromagnetic valve.

9. The electromagnetic brake device in accordance with claim 5, wherein when the push button is pushed toward the locking bar, the locking bar is movable downward in the mounting tube to detach the locking portion of the locking bar from the stop portion of the motor to unlock the mounting tube of the operation unit from the stop portion of the motor and to unlock the rotation plate so that the rotation plate is rotatable freely relative to the fixed seat.

10. The electromagnetic brake device in accordance with claim 9, wherein when the rotation plate of the control mechanism is rotatable freely relative to the fixed seat, the peripheral wall of the rotation plate presses the press button of the control mechanism toward the electromagnetic valve successively to drive the electromagnetic valve.

11. The electromagnetic brake device in accordance with claim 5, wherein the lower portion of the mounting tube of the operation unit is secured on the upper portion of the rotation plate of the control mechanism by two locking screws.

12. The electromagnetic brake device in accordance with claim 11, wherein the locking screws are extended through two fixing holes of the lower portion of the mounting tube of the operation unit and screwed into two screw bores of the upper portion of the rotation plate of the control mechanism.

13. The electromagnetic brake device in accordance with claim 5, wherein the locking bar of the operation unit has a substantially inverted L-shaped profile.

14. The electromagnetic brake device in accordance with claim 7, wherein the limit plate of the motor has a substantially 7-shaped cross-sectional profile.

15. The electromagnetic brake device in accordance with claim 1, wherein the control mechanism is mounted between the motor and the operation unit.

16. The electromagnetic brake device in accordance with claim 1, wherein the fixed seat of the control mechanism has a substantially cylindrical shape.

17. The electromagnetic brake device in accordance with claim 2, wherein the lower portion of the rotation plate of the control mechanism is rotatably mounted on the fixed seat by a pivot screw.

18. The electromagnetic brake device in accordance with claim 17, wherein the pivot screw is extended through a through hole of the rotation plate and a through bore of the fixed seat and screwed into a nut.

19. The electromagnetic brake device in accordance with claim 5, wherein the elastic member of the operation unit is received in the upper portion of the mounting tube.

20. The electromagnetic brake device in accordance with claim 5, wherein the upper portion of the mounting tube has a stepped shoulder to stop the elastic member.
